(19) United States
(12) Patent Application Publication
(10) Pub. No.: US 2025/0175058 A1
(43) Pub. Date: May 29, 2025

(54) INTEGRATED GENERATOR/CONVERTER FOR TURBINE APPLICATIONS

(71) Applicant: The Regents of The University of Michigan, Ann Arbor, MI (US)

(72) Inventor: Heath F. HOFMANN, Ann Arbor, MI (US)

(21) Appl. No.: 18/948,739

(22) Filed: Nov. 15, 2024

Related U.S. Application Data
(60) Provisional application No. 63/603,196, filed on Nov. 28, 2023.

(51) Int. Cl. H02K 7/18; H02K 1/2786; H02K 11/00; H02K 11/33

(52) U.S. Cl. CPC H02K 7/1823; H02K 1/2786; H02K 11/0094; H02K 11/33; H02K 2203/03

(57) ABSTRACT

An integrated generator/converter and turbine includes a turbine wheel having a plurality of turbine blades connected to an annular rim. A rotor is mounted to the annular rim and includes dual rows of permanent magnets circumferentially surrounding the annular rim and each row spaced axially from one another. A stator is mounted to a housing and includes a plurality of coils aligned between the dual rows of permanent magnets of the rotor.

### CROSS-REFERENCE TO RELATED APPLICATIONS

This application claims the benefit of U.S. Provisional Application No. 63/603,196, filed on Nov. 28, 2023.

### FIELD

The present disclosure relates to an integrated generator/converter for turbine applications.

### BACKGROUND

This section provides background information related to the present disclosure which is not necessarily prior art.

In the quest for sustainable energy, turbines play a critical role. Turbines are used to convert fluid flow, be it air (wind turbine) or liquid (marine turbine), into electricity. The components of a wind turbine typically include a rotor, a gearbox, a generator, and a converter. The turbine rotor converts the fluid flow into rotational motion. A key aspect of the turbine is the electrical generator that converts the mechanical rotation of the rotor into electrical power. This generator is connected to a power electronic circuit or converter that processes the generator electrical output (variable-frequency AC) into a form that is suitable for transmission to the electrical loads (DC or fixed-frequency AC). In some turbine designs a gearbox is connected between the turbine rotor and the generator to increase the generator speed. However, the gearbox is a significant source of failure and so it is desirable to use direct drive designs, which do not have a gearbox.

The electrical generator and converter should be highly efficient, so that most of the mechanical power is converted into usable electricity. The generator/converter should also have a high specific power; i.e., power generated divided by generator mass. This is particularly important for wind turbines as the weight of the generator impacts the size of the “tower” which elevates the turbine to the necessary height.

The generator/converter should have a low cost. High-performance generators often use rare-earth permanent magnets. However, the costs of rare-earth materials are volatile due to geopolitical issues and limited rare-earth mining in the United States, and so it is desirable to design generators that do not use these materials. Another aspect of the cost is manufacturing. Care must be taken in the design process to ensure that the resulting generator can be affordably manufactured.

The generator should also have low “cogging” torque, or torque ripple. Cogging torque tries to keep the turbine at specific angular positions, and this can prevent the turbine from spinning at low fluid velocities, preventing power generation. The cut-in speed for turbines is defined as the lowest fluid velocity that still allows power production. While there is not much power produced at low fluid velocities, over time a significant amount of energy can be collected from the turbine under these conditions.

Finally, it is also important that the generator and converter be robust to failure. A number of common failure mechanisms in turbine generators include electrical insulation degradation resulting in short circuits, corrosion of generator materials and mechanical failure of generator bearings.

The conventional converter also has multiple failure mechanisms due to its complexity. It is noted for future reference that two of the lowest failure mechanisms in these converters are diodes (1%) and passive components (4%).

From a mechanical perspective, electrical generators produce magnetic forces on the turbine rotor. These forces are oriented in such a way to exert torque on the rotor. This torque is given by the product of the tangential force f and the radius or moment arm r where the force is applied:

$$τ = r \times f \qquad ( Eq . 1 )$$

The magnitude of the magnetic forces produced by the generator are proportional to the size of the generator components. Hence, to maximize the specific power of a generator the moment arm radius should be as large as possible.

The product of torque t and the angular velocity or of the turbine is the electromechanical power pₑₘ; i.e., the power that is converted from mechanical into electrical form.

$${p}_{em} = {τω}_{r} \qquad ( Eq . 2 )$$

From an electrical perspective, generators work by using rotor movement to induce AC voltages in coils of wire, from which electric current and hence power can be extracted.

These voltages are generated due to time-varying magnetic fluxes flowing through the coils, as stated in Faraday's Law. In many turbine generator designs the magnetic fluxes are produced by permanent magnets, with soft magnetic materials used to amplify the magnetic flux and guide it through the coils.

The voltage v induced in the coils by the magnetic field is calculated as

$$v = {N}_{t} d Φ / dt , \qquad ( Eq . 3 )$$

where Nₜ is the number of turns in the wire coil and @ is the magnetic flux flowing through the coil. This flux can be written as

$$Φ = BA , \qquad ( Eq . 4 )$$

where B is the magnetic flux density and A is the area within the coil. If this flux density is varying sinusoidally with time at a frequency fₑ, hereafter referred to as the electrical frequency, the voltage is also sinusoidal (AC) with a peak value

$${V}_{pk} = 2 π {f}_{e} {N}_{t} {B}_{pk} A \qquad ( Eq . 5 )$$

The voltage levels that can be achieved, and hence the electrical power that can be generated, therefore depend heavily upon the electrical frequency fₑ that can be achieved in the design.

Designing turbine systems where the generator operates at high electrical frequencies can be challenging. The relationship between the electrical frequency fe and the angular velocity of the rotor fr of a permanent magnet generator is given by

$$fe = {N}_{p} / 2 {f}_{r} , \qquad ( Eq . 6 )$$

Where Np is the number of poles (i.e., north and south) of the generator. In permanent magnet generators this typically corresponds to the number of magnets.

Achieving the high electrical frequencies necessary to fully exploit the capabilities of the generator either requires a large number of poles, a high generator rotor speed, or both.

Achieving a high number of magnetic poles in conventional generator designs is difficult due to the limited dimensions of the generator. At some point the magnets get so small and so close together that the magnetic fields generated by the magnets do not cross the air gap between the rotor and stator.

Achieving a high generator rotor speed is also a nontrivial endeavor in turbine sustainable energy applications, as the turbine angular velocity is determined by the fluid velocity and is usually relatively low.

The angular velocity of the turbine is dictated by the fluid velocity and is typically relatively low. Gearboxes are therefore often used to make the generator rotor speed much higher than the turbine speed. However, the addition of a gearbox adds mass, cost, and mechanical power losses. A gearbox with a large speed ratio also has significant static friction, which increases the cut-in speed of the turbine. Finally, as mentioned earlier, gearbox failure is a very common failure mechanism in turbine applications. It is therefore desirable to avoid the use of gearboxes if possible.

A key component of generators is the soft magnetic material used to enhance and guide the magnetic flux. These materials have a saturation flux density Bₛₐₜ that limits the flux density levels in the machine. They also have a practical frequency limit fₘₐₓ due to so-called “core losses” (i.e., hysteresis and eddy current losses) in the material that increase with frequency. A useful figure of merit for comparing different soft magnetic materials for generator designs with high specific power is therefore

$$FoM = {B}_{sat} {f}_{max} / ρ \qquad ( Eq . 7 )$$

where ρ is the density of the material. Figures of merit for different soft magnetic materials are provided below.

TABLE 1
Figures of merit for different soft magnetic materials

| Material | Bsat (T) | fₘₐₓ (kHz) | ρ (g/cm\hat{ }3) | FoM |
|---|---|---|---|---|
| Silicon steel | 1.8 | 1 | 7.6 | 0.24 |
| Iron-cobalt alloy | 2.4 | 5 | 8.1 | 1.48 |
| MnZn ferrite | 0.5 | 100 | 4.8 | 10.4 |

It can be seen that ferrites have the highest figure-of-merit score. As a result, ferrites are the de facto material for the soft magnetic “cores” used in power electronic inductors and transformers.

Ferrites are also natural electrical insulators and therefore don't require electrical insulation between the core and the coil as silicon steel and the iron-cobalt alloys do. This is a significant benefit, as electrical shorts between the core and coil due to insulation failures are another major failure mechanism in electric generators.

Silicon steel and iron-cobalt alloys are also subject to rusting whereas ferrites, as they are already oxides, are not subject to rust. This is particularly important in wind and marine turbine applications, as the environment can be highly corrosive.

However, ferrites are not typically used in electric motor/generator designs. This is mainly due to their relatively low saturation flux density and because it is difficult to achieve the high electrical frequencies necessary to fully exploit ferrite's power processing capabilities. Either very high rotor speeds (requiring a high-ratio gearbox) or an extremely large number of poles in the design is required.

Similarly, ferrite permanent magnets are not often used in high-performance generator applications as their remanent flux density Br is substantially lower than other magnet options, as shown in Table 2.

TABLE 2
Permanent magnet properties.

| Magnet Material | Bᵣ | μₘ |
|---|---|---|
| Ferrite | 0.25 T-0.4 T | 1.1_{μ0} |
| Alnico | 0.55 T-1.1 T | 1.3_{μ0}-7_{μ0} |
| Samarium Cobalt | 0.9 T-1.2 T | 1.05_{μ0} |
| Neodymium Iron Boron | 1.1 T-1.5 T | 1.05_{μ0} |

However, ferrite permanent magnets share the attractive properties of soft ferrites. In addition, ferrite permanent magnets do not require the rare-earth materials used in high-performance magnets (samarium cobalt and neodymium iron boron). These rare-earth materials have high cost volatility, and so there are efforts to find alternatives.

### SUMMARY

This section provides a general summary of the disclosure, and is not a comprehensive disclosure of its full scope or all of its features.

The present disclosure is directed to a generator/converter design for turbine applications. The proposed generator/converter is distributed along the outer circumference of the turbine rotor. The generator has an axial gap design with a single-stator/dual-rotor configuration.

The proposed generator/converter possesses an extremely high number of poles and phases, which results in very high specific torque and power capability. The resulting high electrical frequencies produced by the generator allows the practical use of ferrite soft magnetic materials, which have superior core loss and corrosion properties when compared to silicon iron. These materials are also nonconductive, thereby dramatically reducing the possibility of electrical shorts in the generator. The design also allows the use of ferrite permanent magnets, making the design free of rare earth materials which have high cost volatility.

Each phase of the generator is connected to a half-bridge diode converter attached to a common DC bus voltage. The AC stator can be assembled using flexible printed circuit board (PCB) and conventional PCB assembly techniques. The result is a cost-effective generator design that has high performance and is highly resistant to failure.

According to an aspect of the present disclosure, an integrated generator/converter and turbine includes a turbine wheel having a plurality of turbine blades connected to an annular rim. A rotor is mounted to the annular rim and including dual rows of permanent magnets circumferentially surrounding the annular rim and each row is spaced axially from one another. A stator is mounted to a housing and includes a plurality of coils aligned between the dual row of permanent magnets of the rotor.

According to another aspect, the stator includes a flexible printed circuit board strip including the plurality of coils soldered to the flexible printed circuit board strip.

According to another aspect, each of the plurality of coils is connected with an AC/DC converter.

According to another aspect, each AC/DC converter includes a pair of diodes and a capacitor.

According to another aspect, the diodes and the capacitors are mounted to the flexible printed circuit board strip.

According to another aspect, each converter includes a fusible link in series with the diodes and capacitor.

According to another aspect, the dual row of permanent magnets are ferrite permanent magnets.

According to another aspect, the dual rows of permanent magnets each include at least 36 permanent magnets.

According to another aspect, the plurality of coils include at least 36 coils.

According to a further aspect, an integrated generator/converter and turbine, includes a turbine wheel having a plurality of turbine blades connected to an annular rim. A rotor mounted to the annular rim and including permanent magnets circumferentially surrounding the annular rim and each row spaced axially from one another. A stator including a plurality of coils mounted to a flexible printed circuit board that surrounds the annular rim.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic view of an integrated generator/converter design for turbine applications according to the principles of the present disclosure;

FIG. 2 is a partial cross-sectional view of the integrated generator/converter for a turbine according to the principles of the present disclosure;

FIG. 3 is a side plan view of a stator for the integrated generator/converter for a turbine;

FIG. 4 is a partial plan view of an interior of the stator of FIG. 3;

FIG. 5 is a partial side plan view of stator of FIG. 3;

FIG. 6 is a partial plan view of an exterior of the stator of FIG. 3; and

FIG. 7 is a schematic view of the generator/converter circuit.

Corresponding reference numerals indicate corresponding parts throughout the several views of the drawings.

### DETAILED DESCRIPTION

Example embodiments will now be described more fully with reference to the accompanying drawings.

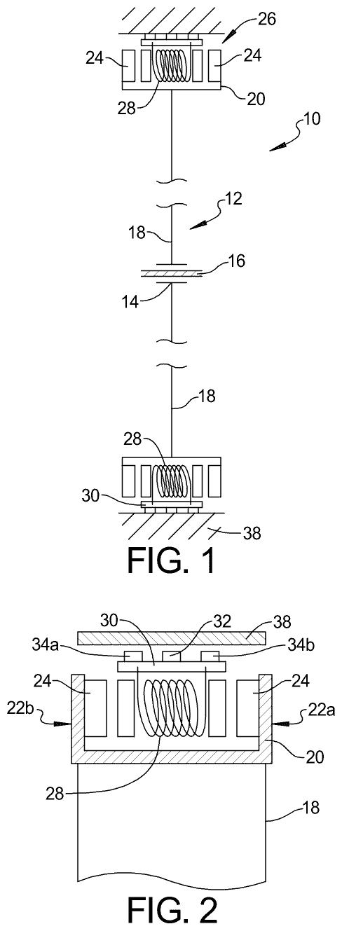

With reference to FIG. 1, an integrated generator/converter 10 for a turbine 12 is shown. The turbine 12 includes a hub 14 rotatably supported along an axis 16. A plurality of turbine blades 18 extend radially outward from the hub 14 and are connected at an outward end to a rotor 20. The turbine blades 18 are designed to engage with a working fluid, typically air or water, for rotation of the rotor 20 about the axis 16. The rotor 20 supports two rows 22a, 22b of a plurality of permanent magnets 24 in an annular arrangement around the rotor 20. The two rows of permanent magnets 22a, 22b are on opposite sides of a stator 26 having a plurality of phases 28 each including a copper coil wrapped around a soft magnetic core arranged annularly along the stator 26.

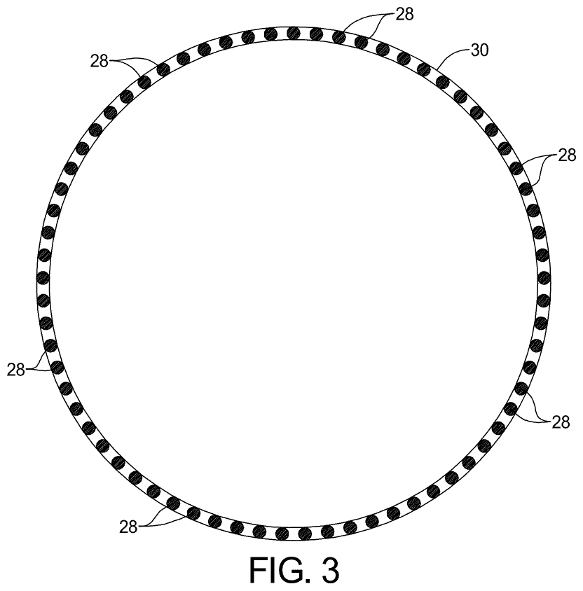

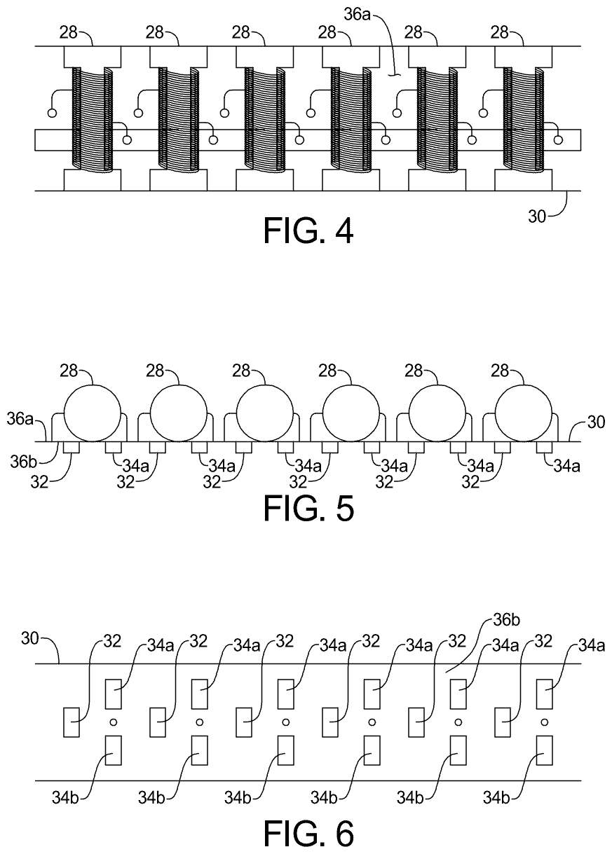

FIG. 3 shows the stator 26 with the phases 28 shown spaced circumferentially around the stator 26. The phases 28 include cylindrical coils that are axially aligned parallel to the axis 16 of the turbine 12. As shown in FIGS. 4-6, the phases 28 can be fixed to a first surface 36a of a flexible printed circuit board 30. The phases 28 are each connected to a capacitor 32 and a pair of diodes 34a, 34b which can be mounted to a second surface 36b of the printed circuit board 30. The flexible printed circuit board 30 extends around an inner circumference of a stator housing 38.

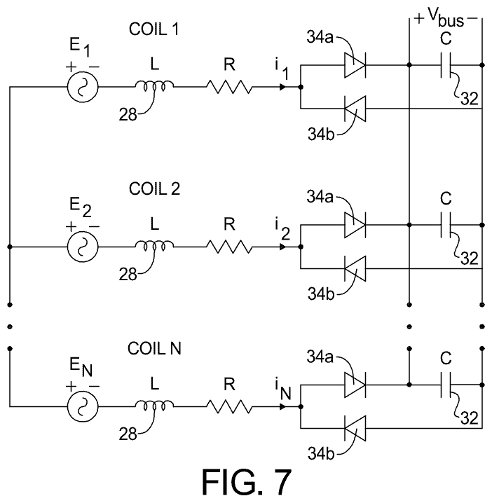

FIG. 7 shows a circuit connection between the phases 28, the diodes 34a, 34b and the capacitor 32.

The proposed integrated generator/converter 10 for wind/water turbines 12 consists of a design that is distributed along the outer circumference of the turbine blades 18, as shown in FIGS. 1 and 2. Placing the generator/converter 10 at the outer diameter of the turbine 12 maximizes the moment arm, which maximizes the torque for a given amount of magnetic force produced by the generator 10.

The proposed generator 10 is an axial-gap machine, which means the magnetic fields flow in the axial direction in the air gap, with a dual rotor 24 and a single stator 26, where the rotors consist of permanent magnets 24 and soft magnetic back irons and the stator 26 consists of a large number of phases consisting of copper coils wrapped around soft magnetic cores. This structure will result in a radially centering magnetic force produced by the generator 10. Axial magnetic forces are ideally cancelled due to the presence of permanent magnets 24 on both sides of the stator 26.

The proposed distributed generator 10 allows for an extremely high number of poles 24 (>50) in the design and hence operation at high electrical frequencies. This enables the practical use of ferrite materials with all their advantages, although conventional soft magnetic materials such as silicon steel can be used in the generator design as well.

Each stator coil 28 (69 are shown) represents a different phase, which is connected to a DC bus through a half-bridge AC/DC converter, as shown in FIG. 7. The converters consist solely of diodes 34a, 34b and passive capacitors 32, the two components with the lowest failure rates in power electronic converters.

Fusible links R are added to the circuit in series with the diodes and capacitors; should a diode 34a, 34b, a capacity or 32, or a coil 28 experience a short circuit, the fusible links R will remove that phase from the circuit. Due to the large number of phases 28, the removal of a single phase due to an electrical short will not have a significant effect on the generator performance.

The number of poles 24 and phases 28 are slightly different. This difference creates an averaging effect which effectively eliminates cogging torque, torque ripple, and electrical power oscillations in the output of the converter 10.

The generator stator/converter will be constructed in the same way a typical electronic circuit is constructed, except using flexible printed circuit board (PCB) technology, as shown in FIGS. 3-6. The stator core/coils 28 will be constructed as a single surface-mount electronic component, like an inductor, and so conventional inductor manufacturing techniques can be used.

The phases 28, capacitors 32, and converter diodes 34a, 34b can then be assembled onto the flexible PCB 30 using pick-and-place machines 40. These machines 40 can add components to a PCB 30 at a rate on the order of 10 components per second. Once the components 28, 32, 34a, 34b have been placed they are soldered to the flexible PCB 30 using wave-soldering techniques. The solder not only creates the electrical connections but also holds the coils 28 in precise locations to create the AC stator structure 26.

Once component population and soldering is completed, the flexible PCB 30 will then be bent into a closed circle and fixed to the structural components 38 of the stator 26, thereby completing the stator manufacture. The bends in the flexible PCB 30 should occur in locations without components to avoid stressing the solder connections.

Details of a proposed generator, suitable for a home wind turbine, are shown in Table 3. Ferrite permanent magnet and soft magnetic materials were used in the design, thereby eliminating concerns with coil/core electrical shorts and corrosion of the magnetic materials. Due to the very high number of poles in the design (614) the specific torque (i.e., torque per unit mass) is superior to that of conventional high-torque machine designs that use silicon-iron for the soft magnetic material and rare-earth magnets. It is anticipated that design optimization will further increase performance. Furthermore, scaling to large turbines and higher power levels is expected to further increase performance, as the higher number of achievable poles, and hence electrical frequencies, will increase and hence become closer to the operating limits of ferrites.

TABLE 3
Estimated performance of example generator/converter design

| Turbine diameter | 5 | ft. |
|---|---|---|
| Turbine/generator rotational velocity | 750 | rpm |
| Number of generator poles | 614 | |
| Electrical frequency | 3.84 | kHz |
| Number of generator phases | 613 | |
| Core material | Ferrite | |
| Permanent Magnet Material | Ferrite | |
| Generator active material mass | 2.0 | lb. |
| Max electrical power | 1.80 | kW |
| Generator/converter efficiency at max. | 92.6% | |
| power | | |
| Max. torque | 24.8 | N-m |

| | |
|---|---|
| Generator/converter efficiency at 1.5 kW | 94.5% |
| electrical power operating point | |
| Generator/converter efficiency at 1 kW | 96.5% |
| electrical power operating point | |
| Generator/converter efficiency at 500 W | 98.0% |
| electrical power operating point | |

The benefits of the proposed generator/converter 10 for turbine applications include: a “direct drive” generator (i.e., no gearbox necessary), high efficiency, high specific torque/power (i.e., torque/power per unit weight), cost-effective stator manufacture with “pick-and-place” equipment commonly used in the manufacture of printed circuit boards, extremely low cogging torque and torque ripple due to high phase count, and radially centering magnetic forces reduce bearing requirements allowing for lower bearing drag. The reduced forces should also reduce bearing failure. Ultra-low cogging torque, low bearing drag, and the lack of a gearbox allows for a low “cut-in speed” of the turbine (i.e., fluid velocity at which turbine begins producing power). The stator is fault tolerant (i.e., the loss of a single phase has negligible impact on performance). High electrical frequency enables use of ferrites instead of iron alloys for magnetic materials which reduces possibility of electrical shorts, corrosion of magnetic components, power loss in magnetic materials, and eliminates the need for expensive rare earth materials in permanent magnets. The large ratio of surface area to volume of the generator makes it easy to remove heat and so the distributed generator/converter structure simplifies cooling.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An integrated generator/converter and turbine, comprising:
a turbine wheel having a plurality of turbine blades connected to an annular rim;
a rotor mounted to the annular rim and including dual rows of permanent magnets circumferentially surrounding the annular rim and each row spaced axially from one another; and
a stator mounted to a housing and including a plurality of coils aligned between the dual row of permanent magnets of the rotor.

2. The integrated generator/converter and turbine according to claim 1, wherein the stator includes a flexible printed circuit board strip including the plurality of coils soldered to the flexible printed circuit board strip.

3. The integrated generator/converter and turbine according to claim 1, wherein each of the plurality of coils is connected with an AC/DC converter.

4. The integrated generator/converter and turbine according to claim 3, wherein each AC/DC converter includes a pair of diodes and a capacitor.

5. The integrated generator/converter and turbine according to claim 4, wherein the diodes and the capacitors are mounted to the flexible printed circuit board strip.

6. The integrated generator/converter and turbine according to claim 5, wherein each converter includes a fusible link in series with the diodes and capacitor.

7. The integrated generator/converter and turbine according to claim 1, wherein the dual row of permanent magnets are ferrite permanent magnets.

8. The integrated generator/converter and turbine according to claim 1, wherein the dual rows of permanent magnets each include at least 36 permanent magnets.

9. The integrated generator/converter and turbine according to claim 1, wherein the plurality of coils include at least 36 coils.

10. An integrated generator/converter and turbine, comprising:
a turbine wheel having a plurality of turbine blades connected to an annular rim;
a rotor mounted to the annular rim and including permanent magnets circumferentially surrounding the annular rim and each row spaced axially from one another; and
a stator including a plurality of coils mounted to a flexible printed circuit board that surrounds the annular rim.

11. The integrated generator/converter and turbine according to claim 10, wherein the plurality of coils are soldered to the flexible printed circuit board strip.

12. The integrated generator/converter and turbine according to claim 10, wherein each of the plurality of coils is connected with a AC/DC converter.

13. The integrated generator/converter and turbine according to claim 12, wherein each AC/DC converter includes a pair of diodes and a capacitor.

14. The integrated generator/converter and turbine according to claim 13, wherein the diodes and the capacitors are mounted to the flexible printed circuit board strip.

15. The integrated generator/converter and turbine according to claim 14, wherein each converter includes a fusible link in series with the diodes and capacitor.

16. The integrated generator/converter and turbine according to claim 10, wherein the plurality of permanent magnets are ferrite permanent magnets.

17. The integrated generator/converter and turbine according to claim 10, wherein the plurality of permanent magnets include dual rows of permanent magnets.

18. The integrated generator/converter and turbine according to claim 10, wherein the dual rows of permanent magnets each include at least 36 permanent magnets.
